(19) United States
(12) Patent Application Publication
(10) Pub. No.: US 2006/0237634 A1
(43) Pub. Date: Oct. 26, 2006

(54) Position sensing device for mobile robots and robot cleaner equipped with the same

(75) Inventor: Sang Yun Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/320,771

(22) Filed: Dec. 30, 2005

(30) Foreign Application Priority Data
Apr. 23, 2005 (KR) 2005-33842

(51) Int. Cl. G06M 7/00

(52) U.S. Cl. 250/221

(57) ABSTRACT

A position sensing device for mobile robots comprises a light-receiving element configured such that light is focused on different positions of the light-receiving element according to the distance from an obstruction, a light-emitting element to emit the light, which is reflected by the obstruction and is incident on the light-receiving element, in a straight line, the light-emitting element serving to emit the light at a predetermined angle to the external jamming light such that an imaginary obstruction formed by an external jamming light incident on the light-receiving element is positioned out of an effective sensing range, a signal processing unit to calculate the distance from the obstruction based on the position where the light incident on the light-receiving element is focused, and an incorrect signal processing unit to determine whether the obstruction is present within the distance considering the change of the distance sensed by the position sensing device while the mobile robot is driven. Consequently, the mobile robot is properly operated although the external jamming light is present, and incorrect recognition of the distance from the obstruction due to reflection of the light, which is emitted while being inclined, not by the obstruction but by a floor of a moving space is prevented.

### BACKGROUND OF THE INVENTION

1. Field of the Invention

The present invention relates to a position sensing device for mobile robots, and, more particularly, to a position sensing device for mobile robots that is capable of sensing the distance from an obstruction while the mobile robot is driven without incorrect recognition of an external jamming light to be the obstruction. Also, the present invention relates to a robot cleaner equipped with the same.

2. Description of the Related Art

Generally, a position sensing device for mobile robots is a device that emits infrared light to sense the distance from an obstruction, from which the infrared light is reflected.

FIGS. 1 and 2 show a conventional position sensing device for mobile robots, wherein FIG. 1 is a view illustrating the construction and operational principle of the position sensing device, and FIG. 2 is a view illustrating the position sensing device when a jamming light is applied to the position sensing device.

Referring first to FIG. 1, the conventional position sensing device comprises: a light-emitting element 2 configured to emit infrared light in a straight line; a light-receiving element 5 configured such that the light, which is reflected by an obstruction, is focused on the light-receiving element; and a signal processing unit 8 configured to measure the distance from the obstruction based on the position of the light focused on the light-receiving element.

The light-emitting element 2 comprises: an infrared light-emitting diode (IR-LED) 3 for emitting infrared light; and a light-transmitting lens 4 for condensing the infrared light emitted from the infrared light-emitting diode 3 such that the infrared light emitted from the infrared light-emitting diode 3 is advanced in a straight line.

The light-receiving element 5 comprises: a light-receiving lens 7 for condensing the infrared light reflected by the obstruction; and a position-sensitive detector 6, on which the infrared light condensed by the light-receiving lens 7 is focused.

The light-receiving element 5 condenses the infrared light at different angles according to the distance from the obstruction, from which the infrared light is reflected. Consequently, the infrared light is focused on the upper part of the position-sensitive detector when the distance from the obstruction is small, i.e., for an obstruction 11a near to the position sensing device. On the other hand, the infrared light is focused on the lower part of the position-sensitive detector when the distance from the obstruction is large, i.e., for another obstruction 11b far from the position sensing device.

The signal processing unit is configured to measure the distance from the obstruction, from which the infrared light is reflected, based on the position of the position-sensitive detector where the infrared light is focused.

In the conventional position sensing device with the above-stated construction, however, an external jamming light emitted from a light source 12a, such as natural light or illumination, is directly incident on the position-sensitive detector 6, as shown in FIG. 2, and the external jamming light incident on the position-sensitive detector 6 is incorrectly recognized to be the infrared light reflected by an obstruction 12b. As a result, it is incorrectly recognized that the obstruction 12b is present although the obstruction 12b is not really present.

### SUMMARY OF THE INVENTION

Therefore, the present invention has been made in view of the above problems, and it is an object of the present invention to provide a position sensing device for mobile robots that is capable of sensing the distance from an obstruction while the mobile robot is driven without incorrect recognition of an external jamming light to be the obstruction.

It is another object of the present invention to provide a robot cleaner equipped with such a position sensing device for mobile robots.

In accordance with one aspect of the present invention, the above and other objects can be accomplished by the provision of a position sensing device for mobile robots, comprising: a light-receiving element configured such that light is focused on different positions of the light-receiving element according to the distance from an obstruction, from which the light is reflected; a light-emitting element configured to emit the light, which is reflected by the obstruction and is incident on the light-receiving element, in a straight line, the light-emitting element serving to emit the light at a predetermined angle to the external jamming light such that an imaginary obstruction formed by an external jamming light incident on the light-receiving element is positioned out of an effective sensing range, within which the mobile robot is driven, among a sensible range of the distance from the obstruction; and a signal processing unit configured to calculate the distance from the obstruction based on the position where the light incident on the light-receiving element is focused.

Preferably, the position sensing device further comprises: an incorrect signal processing unit configured to determine whether the obstruction is present within the distance considering the change of the distance sensed by the position sensing device while the mobile robot is driven.

Preferably, the light-emitting element comprises: an infrared light-emitting diode for emitting infrared light; and a light-transmitting lens for condensing the infrared light emitted from the infrared light-emitting diode such that the infrared light emitted from the infrared light-emitting diode is advanced in a straight line.

Preferably, the light-receiving element comprises: a light-receiving lens for condensing the light reflected by the obstruction; and a position-sensitive detector configured such that the light condensed by the light-receiving lens is focused on the position-sensitive detector.

Preferably, the light-emitting element is configured to emit the light at a predetermined angle, at which the degree of deviation in position of the imaginary obstruction sensed by the light-receiving element out of the effective sensing range is greater than the minimum unit distance distinguishable according to the accuracy of the signal processing unit.

Preferably, the light-emitting element is configured to emit the light at a predetermined angle, at which the light emitted from the light-emitting element is directed to a floor of a moving space, which is the maximum distance of the effective sensing range.

In accordance with another aspect of the present invention, there is provided a robot cleaner comprising: at least one position sensing device for emitting light to a floor of a cleaning space at a predetermined angle to the floor of the cleaning space such that the light emitted from the at least one position sensing device is distinguished from an external jamming light to sense the distance from an obstruction, from which the light is reflected; and an information processing unit for transmitting a signal to the at least one position sensing device and receiving a signal from the at least one position sensing device to control a drive unit such that the robot cleaner cleans the cleaning space while the robot is driven in the cleaning space.

Preferably, the robot cleaner further comprises: a case forming the contour of a main body; a cleaning unit mounted at the main body for cleaning the cleaning space; and a drive unit for driving the main body such that the main body is moved on the floor of the cleaning space while supporting the main body.

Preferably, the at least one position sensing device comprises: a light-emitting element configured to emit light in a straight line; a light-receiving element configured such that the light is focused on different positions of the light-receiving element according to the distance from the obstruction, from which the light is reflected; and a signal processing unit configured to calculate the distance from the obstruction based on the position where the light incident on the light-receiving element is focused.

Preferably, the light-emitting element comprises: an infrared light-emitting diode for emitting infrared light; and a light-transmitting lens for condensing the infrared light emitted from the infrared light-emitting diode such that the infrared light emitted from the infrared light-emitting diode is advanced in a straight line.

Preferably, the light-receiving element comprises: a light-receiving lens for condensing the light reflected by the obstruction; and a position-sensitive detector configured such that the light condensed by the light-receiving lens is focused on the position-sensitive detector.

Preferably, the light-emitting element is configured to emit the light at a predetermined angle, at which the degree of deviation in position of an imaginary obstruction sensed by the light-receiving element out of an effective sensing range is greater than the minimum unit distance distinguishable according to the accuracy of the signal processing unit.

Preferably, the light-emitting element is configured to emit the light at an angle of between 10 and 15 degrees to the floor of the cleaning space.

Preferably, the robot cleaner further comprises: an incorrect signal processing unit incorporated in the information processing unit or configured to transmit a signal to the information processing unit and receive a signal from the information processing unit for determining whether the obstruction is present within the distance considering the change of the distance sensed by the at least one position sensing device while the robot cleaner is driven.

Preferably, the incorrect signal processing unit performs an algorithm comprising: a first step of driving the robot cleaner; a second step of sensing an obstruction within the effective sensing range using the at least one position sensing device; a third step of driving the robot cleaner in correspondence to the obstruction; a fourth step of determining whether the distance from the obstruction is increased; a fifth step of determining whether the robot cleaner approaches the obstruction; and a sixth step of detouring the obstruction or stopping the movement of the robot cleaner when the robot cleaner approaches the obstruction.

At the first step, the second step is frequently called while the mobile robot is driven.

At the fourth step, when the distance from the obstruction is increased, the process returns to the second step, and when the distance from the obstruction is not increased, the process moves to the fifth step.

Preferably, the at least one position sensing device comprises a plurality of position sensing devices, some of which are configured such that the angles between lights emitted from the respective position sensing devices and the floor of the cleaning space are different.

Preferably, the at least one position sensing device comprises a plurality of position sensing devices, some of which are configured such that the heights of the respective position sensing devices from the floor of the cleaning space are different.

Preferably, the at least one position sensing device comprises a plurality of position sensing devices, some of which are configured such that the heights of the respective position sensing devices from the floor of the cleaning space are the same, and the angles between lights emitted from the respective position sensing devices disposed at the same height and the floor of the cleaning space are the same.

Preferably, the at least one position sensing device comprises a plurality of position sensing devices, some of which are configured to emit light in the same direction although the heights and the light-emitting angles of the respective position sensing devices are different.

According to the present invention, it is not possible that the external jamming light is incorrectly recognized to be the obstruction. Consequently, the present invention has the effect of properly operating the mobile robot and the robot cleaner although the external jamming light is present.

Furthermore, the position sensing device for mobile robots and the robot cleaner equipped with the same have the incorrect signal processing unit or the plurality of position sensing devices. Consequently, the present invention has the effect of preventing the incorrect recognition of the distance from the obstruction due to reflection of the light, which is emitted while being inclined, not by the obstruction but by the floor of the moving space, in which the mobile robot or the robot cleaner is driven.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 show a conventional position sensing device for mobile robots, wherein

FIG. 1 is a view illustrating the construction and operational principle of the position sensing device, and

FIG. 2 is a view illustrating the position sensing device when a jamming light is applied to the position sensing device;

FIGS. 3 to 7 show a position sensing device for mobile robots according to a preferred embodiment of the present invention, wherein

FIG. 3 is a view illustrating the construction of the position sensing device,

FIG. 4 is a view illustrating an incorrect signal generated from the position sensing device,

FIG. 5 is a view illustrating the change of the incorrect signal generated from the position sensing device,

FIG. 6 is a graph illustrating the relation between the distance sensed by the position sensing device and the real distance, and

FIG. 7 is a flow chart illustrating an algorithm performed by an incorrect signal processing unit; and

FIG. 8 is a view showing the construction of a robot cleaner according to a preferred embodiment of the present invention.

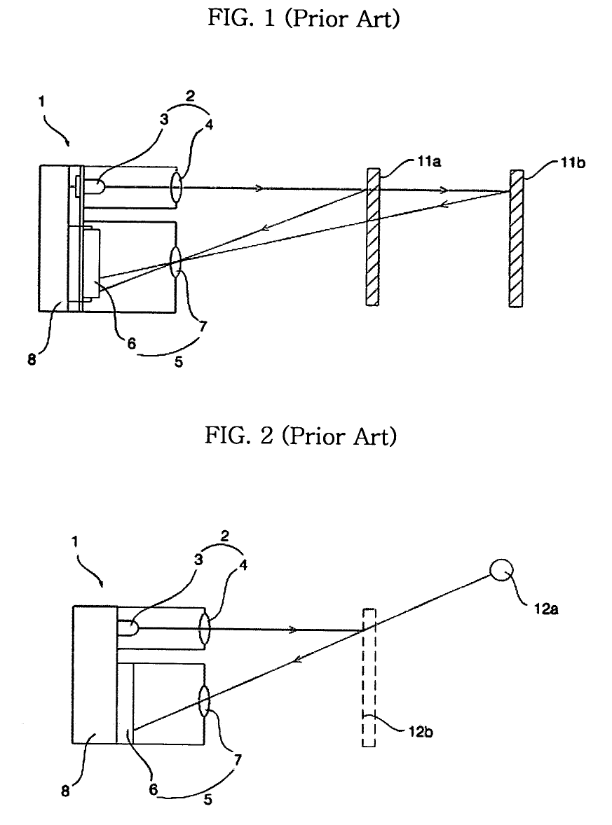

### DESCRIPTION OF THE PREFERRED EMBODIMENTS

Now, preferred embodiments of the present invention will be described in detail with reference to the accompanying drawings.

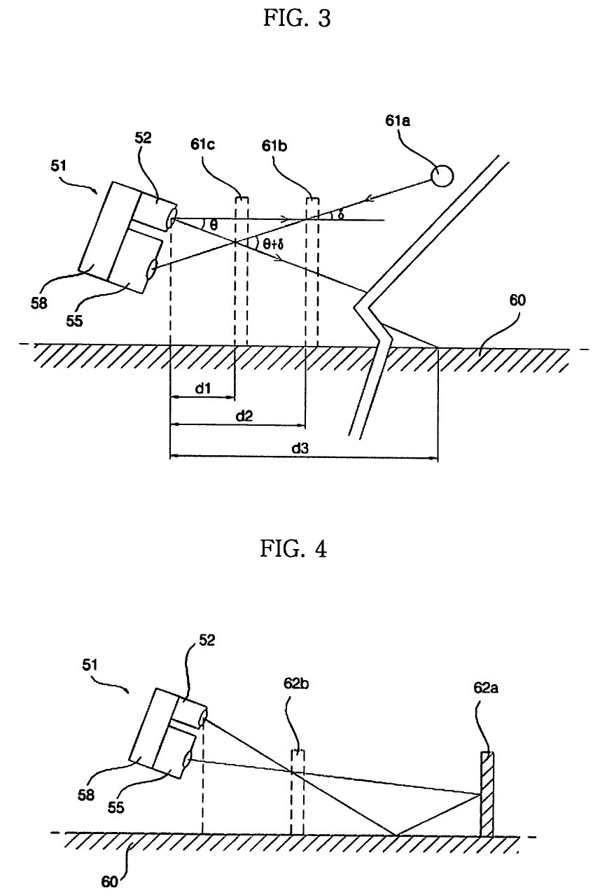

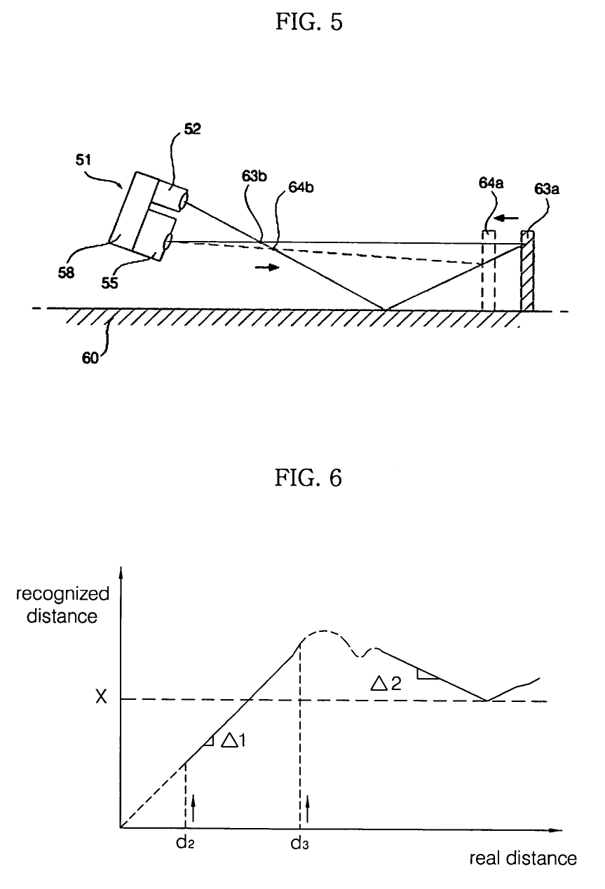

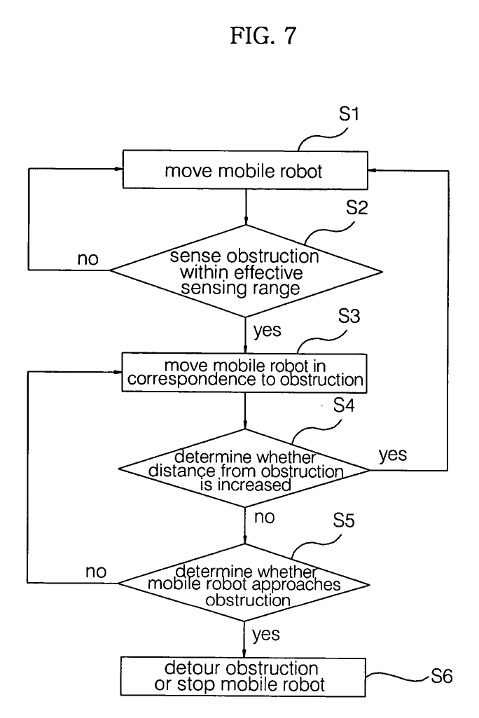

FIGS. 3 to 7 show a position sensing device 51 for mobile robots according to a preferred embodiment of the present invention, wherein FIG. 3 is a view illustrating the construction of the position sensing device 51 , FIG. 4 is a view illustrating an incorrect signal generated from the position sensing device 51, FIG. 5 is a view illustrating the change of the incorrect signal generated from the position sensing device 51, FIG. 6 is a graph illustrating the relation between the distance sensed by the position sensing device and the real distance, and FIG. 7 is a flow chart illustrating an algorithm performed by an incorrect signal processing unit.

As shown in FIG. 3, the position sensing device 51 for mobile robots according to the preferred embodiment of the present invention comprises: a light-emitting element 52 configured to emit light, which is reflected by an obstruction and is incident on a light-receiving element, in a straight line; a light-receiving element 55 configured such that the light is focused on different positions of the light-receiving element 55 according to the distance from the obstruction, from which the light is reflected; a signal processing unit 58 configured to calculate the distance from the obstruction based on the position where the light incident on the light-receiving element 55 is focused; and an incorrect signal processing unit (not shown) configured to determine whether an obstruction is present within the distance considering the change of the distance sensed by the position sensing device 51 while a mobile robot is driven.

Preferably, the light-emitting element 52 comprises: an infrared light-emitting diode (IR-LED) for emitting infrared light; and a light-transmitting lens for condensing the infrared light emitted from the infrared light-emitting diode such that the infrared light emitted from the infrared light-emitting diode is advanced in a straight line.

The light-receiving element 55 comprises: a light-receiving lens for condensing the infrared light reflected by the obstruction; and a position-sensitive detector, on which the infrared light condensed by the light-receiving lens is focused.

The light-receiving element 55 is configured such that an incidence angle of the infrared light incident on the position detector in parallel with the infrared light emitted from the light-emitting element 52 is 0 degrees, although the light-receiving element 55 may be configured such that the incidence angle of the infrared light incident on the position detector in parallel with a floor 60 of a moving space in which the mobile robot is driven is 0 degrees.

The light-receiving lens condenses the infrared light at different angles according to the distance from the obstruction, from which the infrared light is reflected. As a result, the infrared light is focused on the upper part of the position-sensitive detector of the light-receiving lens when the distance from the obstruction, from which the infrared light is reflected, is small, i.e., when the obstruction is near to the position sensing device. On the other hand, the infrared light is focused on the lower part of the position-sensitive detector of the light-receiving lens when the distance from the obstruction, from which the infrared light is reflected, is large, i.e., when the obstruction is far from the position sensing device.

Preferably, the position-sensitive detector is a semiconductor having two output terminals, output balances of which are changed according to the positions where the light is focused.

The signal processing unit 58 is an operation circuit for receiving the output balance of the position-sensitive detector, calculating the distance from the obstruction from the output balance, and outputting the calculated distance in the form of a signal.

The range of the distance from the obstruction, which can be sensed by the position sensing device 51, is set based on the intensity of light emitted from the light-emitting element 52, the light absorptivity and sensitivity of the light-receiving element 55, the operation method of the signal processing unit 58. Also, an effective sensing range d2˜d3, which is necessary to drive the mobile robot, is set within the sensible distance range.

The effective sensing range d2˜d3 is limited to the range between the effective minimum distance d2 and the effective maximum distance d3. The effective minimum distance d2 and the effective maximum distance d3 are set in consideration of the distance between the light-receiving element 55 and the contour of the mobile robot or the distance at which the stoppage of the movement of the mobile robot is required to prevent the mobile robot from colliding with the obstruction, and the distance at which the obstruction is to be sensed to predict reduction of the speed of the mobile robot or the route along which the mobile robot is driven in correspondence to the obstruction.

The light-emitting element 52 is configured to emit light having a predetermined angle θ+δ to an external jamming light such that the external jamming light, which is incorrectly recognized to be the light incident on the light-receiving element 55 and reflected by the obstruction, is deviated from the effective sensing range d2˜d3.

The range of the incident angle θ+δ, at which the jamming light is incident on the light-receiving element 55, is set according to the distance to a light source 61a of the jamming light and the position of the mobile robot.

The angle of the light emitted from the light-emitting element 52 is set to be an angle at which the distance from a false-imaged obstruction 61b is incorrectly recognized when the external jamming light is incident on the light-receiving element 55 at the minimum incidence angle is deviated from the effective sensing range d2-d3 (61c). The degree at which the effective sensing range is deviated is set to be a clearance margin d2-d1, which is slightly greater than the minimum unit distance distinguishable according to the accuracy of the position sensing device.

Preferably, the light emitted from the light-emitting element 52 is directed to the floor 60 of the moving space, in which the mobile robot is driven, positioned within the effective maximum distance d3. In the case that the floor 60 of the moving space, in which the mobile robot is driven, is uneven, it is preferable that the light emitted from the light-emitting element 52 is directed to an imaginary flat floor positioned within the effective maximum distance d3.

Preferably, the mobile robot incorporating the position sensing device 51 with the above-stated construction comprises: a case forming the contour of a main body; a drive unit for driving the main body such that the main body is driven on the floor of the moving space, in which the mobile robot is driven, while supporting the main body; an obstruction sensing unit for sensing an obstruction in the moving space, the obstruction sensing unit including the position sensing device 51; and an information processing unit for exchanging a signal with the drive unit and the obstruction sensing unit to control the drive unit and the obstruction sensing unit and to input/output, process, and store the signal.

Preferably, the drive unit comprises: two main wheels rotatably mounted at the right and left sides of the lower part of the main body, respectively; two wheel motors connected to the main wheels for rotating the main wheels clockwise or counterclockwise, respectively; and a caster mounted at the lower part of the main body for supporting the main body while the caster is rotated in the direction in which the main body is driven.

Preferably, the obstruction sensing unit comprises: a plurality of position sensing devices 51; and a plurality of ultrasonic sensors, light sensors, or impact sensors for sensing the distance from the obstruction or determining whether the obstruction is present or not using reflection of a sound wave or an electromagnetic wave or impact caused due to the movement of the mobile robot.

Preferably, the information processing unit is a microcomputer comprising: an input/output part for receiving a signal from the outside and transmitting a signal to the outside; a memory for storing the received/transmitted or processed signal or other necessary information; a microprocessor for processing the signal or other information and for controlling the operations of the input/output part and the memory; and an interface circuit connected to the input/output part, the memory, and the microprocessor for allowing the signal to be transmitted between the input/output part, the memory, and the microprocessor therethrough.

The incorrect signal processing unit is configured to transmit a signal to the information processing unit and receive a signal from the information processing unit. Preferably, the incorrect signal processing unit is configured to perform an algorithm (see FIG. 7) that determines whether an obstruction is present within the distance considering the change of the distance, while the mobile robot is driven, calculated by the signal processing unit 58.

The incorrect signal processing unit is not limited to an additional unit for exchanging a signal with the information processing unit. For example, the incorrect signal processing unit may be incorporated in the information processing unit such that components of the information processing unit are also used by the incorrect signal processing unit. The algorithm (see FIG. 7) may be stored in the memory, and the algorithm may be performed by the microprocessor.

As illustrated in FIG. 7, the algorithm comprises: a first step of driving the mobile robot (S1); a second step of sensing an obstruction within the effective sensing range using the position sensing device 51 (S2); a third step of driving the mobile robot in correspondence to the obstruction (S3); a fourth step of determining whether the distance from the obstruction is increased (S4); a fifth step of determining whether the mobile robot approaches the obstruction (S5); and a sixth step of detouring the obstruction or stopping the movement of the mobile robot when the mobile robot approaches the obstruction (S6).

At the first step (S1), the second step (S2) is frequently called while the mobile robot is driven.

At the second step (S2), the signal inputted to the microcomputer from the position sensing device 51 is directly received to determine whether the obstruction is present within the effective sensing range. When it is determined that the obstruction is present within the effective sensing range, the process moves to the third step (S3). When it is determined that the obstruction is not present within the effective sensing range, on the other hand, the process returns to the first step (S1).

At the third step (S3), a signal is transmitted to the microcomputer such that the movement of the mobile robot necessary when the obstruction is present within the effective sensing range is accomplished, for example, the mobile robot slowly decelerates, and then the process moves to the fourth step (S4).

At the fourth step (S4), the signal inputted to the microcomputer from the position sensing device 51 is directly received, and it is determined whether the distance from the obstruction is increased due to the movement of the mobile robot at the third step (S3). When it is determined that the distance from the obstruction is increased, the process returns to the second step (S2). When it is determined that the distance from the obstruction is not increased, on the other hand, the process moves to the fifth step (S5).

At the fifth step (S5), it is determined whether the mobile robot approaches the obstruction to the extent that the mobile robot collides with the obstruction. When it is determined that the mobile robot approaches the obstruction to the extent that the mobile robot collides with the obstruction, the process moves to the sixth step (S6). When it is determined that the mobile robot does not approach the obstruction to the extent that the mobile robot collides with the obstruction, on the other hand, the process returns to the third step (S3).

At the sixth step (S6), a signal is transmitted to the microcomputer such that the movement of the mobile robot is stopped, or the mobile robot detours the obstruction.

Now, the operation of the position sensing device for mobile robots with the above-stated construction according to the preferred embodiment of the present invention will be described in detail.

Referring first to FIG. 3, the light-emitting element 52 emits infrared light by means of the infrared light-emitting diode. The emitted infrared light is advanced in a straight line toward the moving space, in which the mobile robot is driven, by the light-transmitting lens, and is then reflected by the obstruction. The reflected infrared light is focused on the position-sensitive detector of the light-receiving element 55. Based on the position of the position-sensitive detector where the infrared light is focused, the output balance of the position-sensitive detector is changed. The signal processing unit 58 converts the output balance into a distance from the obstruction, and transmits the distance.

When a jamming light generated from the external light source is incident on the light-receiving element 55, the position sensing device 51 incorrectly recognizes that the obstructions 61c and 61b are present. The distances d1 and d2 from the incorrectly recognized imaginary obstructions are changed according to the angles θ+δ and δ formed by the infrared light emitted from the light-emitting element 52 and the external jamming light.

The light-emitting element 52 emits light while having the angle θ+δ to the jamming light such that the distance from the imaginary obstruction 61b incorrectly recognized due to the jamming light incident on the light-receiving element 55 at the minimum incidence angle is deviated from the effective sensing range d2˜d3 while the clearance margin d2-d1 is given.

Consequently, when the jamming light is incident on the light-receiving element 55 at an angle greater than the minimum incidence angle, the above-mentioned imaginary obstruction are deviated from the effective sensing range d2˜d3.

When the position sensing device 51 senses the imaginary obstructions due to the jamming light, and the corresponding signal is inputted to the microcomputer, the microcomputer determines that the imaginary obstruction is deviated from the effective sensing range d2˜d3, and therefore, the imaginary obstruction is not recognized.

Meanwhile, it is possible, as shown in FIG. 4, that the infrared light emitted from the light-emitting element 52 is initially reflected by the floor 60 of the moving space, in which the mobile robot is driven, is reflected again by an obstruction 62a, and is then incident on the light-receiving element 55. In this case, the position sensing device 51 incorrectly recognizes that the obstruction 62b is present at the point where the route along which the infrared light is emitted and the route along which the infrared light is reflected again, and the distance from the incorrectly recognized obstruction 62b is inputted to the microcomputer in the form of a signal.

When the infrared light is reflected by the floor 60 of the moving space, in which the mobile robot is driven, is reflected again by an obstruction 63a, and is then incident on the light-receiving element 55, as shown in FIG. 5, the position sensing device 51 recognizes that the distance from the obstruction is increased from 63b to 64b even though the mobile robot is driven toward another obstruction 64a, i.e., from the obstruction 63a to the obstruction 64a.

Specifically, the real distance from the obstruction and the recognized distance, which is sensed by the position sensing device, are the same or are directly proportional to each other (Δ1>0) in the effective sensing range d2˜d3, as shown in FIG. 6. When the obstruction is present at a point remote from the effective sensing range, however, the real distance from the obstruction and the recognized distance, which is sensed by the position sensing device, are inversely proportional to each other (Δ2<0). This phenomenon occurs in the range in which the recognized distance is experimentally above a predetermined value x.

As described above, the incorrect signal processing unit performs the algorithm (see FIG. 7), which uses the inversely proportional relation between the real distance from the obstruction and the recognized distance, to determine whether the obstruction is really present at the distance from the obstruction sensed by the position sensing device.

Referring to FIG. 7, the flow of the algorithm is divided depending on whether the obstruction is initially present either within the effective sensing range or out of the effective sensing range.

When the obstruction is initially present either within the effective sensing range, i.e., when the obstruction is present in the direction to which the mobile robot is turned while the mobile robot is driven, the third step to the fifth step (S3, S4, S5) are repeatedly performed such that the mobile robot detours the obstruction after the mobile robot approaches the obstruction.

When the obstruction is initially present out of the effective sensing range, the second step to the fourth step (S2, S3, S4) are performed, whenever the second step (S2) is called at the first step (S1), until the obstruction is present within the effective sensing range. When the obstruction is present within the effective sensing range, the third step to the fifth step (S3, S4, S5) are repeatedly performed such that the mobile robot detours the obstruction after the mobile robot approaches the obstruction.

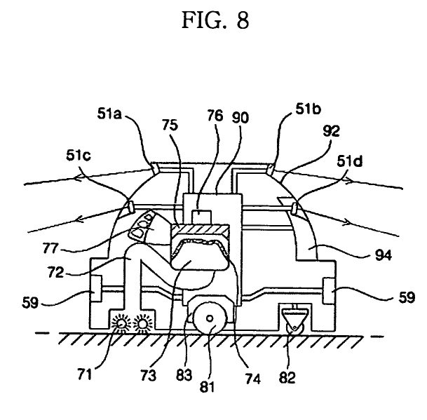

FIG. 8 is a view showing the construction of a robot cleaner according to a preferred embodiment of the present invention.

As shown in FIG. 8, the robot cleaner according to the preferred embodiment of the present invention comprises: a case 92 forming the contour of a main body; a cleaning unit mounted at the main body for cleaning a cleaning space; a drive unit for driving the main body such that the main body is driven on the floor of the cleaning space while supporting the main body; eight position sensing devices 51a, 51b, 51c, and 51d for emitting light to the floor of the cleaning space at a predetermined angle to the floor of the cleaning space such that the light emitted from the position sensing devices is distinguished from an external jamming light to sense the distance from an obstruction, from which the light is reflected; and an information processing unit 90 for transmitting a signal to the position sensing devices and receiving a signal from the position sensing devices to control the drive unit such that the robot cleaner cleans the cleaning space while the robot cleaner is driven in the cleaning space.

Each of the position sensing devices is basically identical in construction to the position sensing device for mobile robots according to the previous embodiment of the present invention (FIG. 3), although the robot cleaner according to the preferred embodiment of the present invention includes an incorrect signal processing unit, which is different from the incorrect signal processing unit of the position sensing device for mobile robots according to the previous embodiment of the present invention.

Specifically, each of the position sensing devices 51a, 51b, 51c, and 51d comprises: a light-emitting element configured to emit light in a straight line; a light-receiving element configured such that the light is focused on different positions of the light-receiving element 55 according to the distance from an obstruction, from which the light is reflected; and a signal processing unit configured to calculate the distance from the obstruction based on the position where the light incident on the light-receiving element is focused.

The angle of the light emitted from the light-emitting element is decided in consideration of the incidence angle of sun light based on the position of illuminations in the cleaning space, the height of windows, and the area of the windows, the minimum incidence angle of the jamming light incident on the light-receiving element based on the area of the cleaning space, and the minimum and maximum distances from the obstruction during the movement of the robot cleaner. Preferably, the angle of the light emitted from the light-emitting element forms an angle of between 10 and 15 degrees with the floor of the cleaning space.

The position sensing devices 51a, 51b, 51c, and 51d are mounted at the front, rear, right, and left sides in pairs at the upper and lower parts, respectively. The position sensing devices 51a and 51b, which are mounted at the upper part, are mounted such that the position sensing devices 51a and 51b are disposed at the same height from the floor of the cleaning space and the angles of the light emitted to the floor of the cleaning space are the same. Similarly, the position sensing devices 51c and 51d, which are mounted at the lower part, are mounted such that the position sensing devices 51c and 51d are disposed at the same height from the floor of the cleaning space and the angles of the light emitted to the floor of the cleaning space are the same. However, the position sensing devices 51a, 51b, 51c, and 51d are mounted such that the angles of the light emitted from the position sensing devices 51a and 51b are different from the angles of the light emitted from the position sensing devices 51c and 51d. For example, the position sensing devices 51a, 51b, 51c, and 51d are mounted such that the angles of the light emitted from the upper-side position sensing devices 51a and 51b are 10 degrees, and the angles of the light emitted from the lower-side position sensing devices 51c and 51d are 12 degrees.

Preferably, the information processing unit 90 is a microcomputer comprising: an input/output part for receiving a signal from the outside and transmitting a signal to the outside; a memory for storing the received/transmitted or processed signal or other necessary information; a microprocessor for processing the signal or other information and for controlling the operations of the input/output part and the memory; and an interface circuit connected to the input/output part, the memory, and the microprocessor for allowing the signal to be transmitted between the input/output part, the memory, and the microprocessor therethrough.

The robot cleaner further comprises: an incorrect signal processing unit configured to perform an algorithm that determines whether an obstruction is present within the distance considering the change of the distance, while the robot cleaner is driven, sensed by the position sensing devices. The incorrect signal processing unit is incorporated in the information processing unit such that components of the information processing unit are also used by the incorrect signal processing unit. The algorithm is stored in the memory, and the algorithm is performed by the microprocessor.

Also, the determination as to whether the obstruction is really present within the distance from the obstruction sensed by the position sensing devices 51a, 51b, 51c, and 51d may be accomplished through the determination as to whether the distances from the obstruction sensed by the position sensing devices 51a and 51c, which emit light in the same direction although the heights and the light-emitting angles of the position sensing devices 51a and 51c are different, are the same. If the difference between the distances from the obstruction are present within the range of error caused due to the accuracy of the position sensing devices 51a and 51c, it is determined that the distances are the same.

Preferably, the cleaning unit comprises: a flow channel formed at the main body, the flow channel having an inlet port 72 and an outlet port 77; a fan 75 mounted in the flow channel for suctioning pollutants from the cleaning space; a brush part 71 mounted at the inlet side of the flow channel for applying a physical force to the pollutant to assist the suctioning operation of the fan 75; a filter 74 mounted in the flow channel for filtering out the pollutants to prevent the pollutants from being introduced into the fan 75 or prevent the pollutant from being discharged from the flow channel; and a dust bag 73 mounted in the flow channel for collecting the suctioned pollutants.

Preferably, the drive unit comprises: two main wheels 81 rotatably mounted at the right and left sides of the lower part of the main body, respectively, for moving the main body while supporting the main body; two wheel motors mounted at the right and left sides of the main body, respectively, while being connected to the main wheels 81 for rotating the main wheels 81 clockwise or counterclockwise, respectively; and a caster 82 mounted at the lower part of the main body for supporting the main body while the caster is rotated in all the directions in which the main body can be moved.

The wheel motors 83 are configured to be rotated clockwise or counterclockwise or stopped according to a signal outputted from the information processing unit 90.

Preferably, the robot cleaner further comprises: a manipulating unit 94 having an interface for allowing a user to manipulate the robot cleaner; and a power supply unit (not shown) for supplying power necessary to operate the robot cleaner. In addition, the robot cleaner further comprises various kinds of sensors 59, such as position sensors for sensing the distance from the obstruction, from which the light emitted in parallel with the floor of the cleaning space is reflected, ultrasonic sensors for sensing the shape of the obstruction or the distance from the obstruction using ultrasonic waves, and floor sensors for sensing the inclination of the floor of the cleaning space.

Now, the operation of the robot cleaner with the above-stated construction according to the preferred embodiment of the present invention will be described.

The incorrect signal processing unit mounted in the microcomputer determines whether the distance from the obstruction sensed by one of the position sensing devices 51a, 51b, 51c, and 51d is increased or decreased, when the robot cleaner is driven, to determine whether the obstruction is really present within the sensed distance.

Also, the microcomputer determines whether the distances from the obstruction sensed by the position sensing devices 51a and 51c, which emit light in the same direction although the heights and the light-emitting angles of the position sensing devices 51a and 51c are different, are the same to determine whether the obstruction is really present within the sensed distance.

Based on the above-described two methods, it is determined whether the obstruction is present within the distance sensed by the position sensing devices 51a and 51c. Consequently, the distance from the obstruction is more accurately determined.

According to the position sensing device for mobile robots and the robot cleaner equipped with the same, as apparent from the above description, it is not possible that the external jamming light is incorrectly recognized to be the obstruction. Consequently, the present invention has the effect of properly operating the mobile robot and the robot cleaner although the external jamming light is present.

Furthermore, the position sensing device for mobile robots and the robot cleaner equipped with the same have the incorrect signal processing unit or the plurality of position sensing devices. Consequently, the present invention has the effect of preventing the incorrect recognition of the distance from the obstruction due to reflection of the light, which is emitted while being inclined, not by the obstruction but by the floor of the moving space, in which the mobile robot or the robot cleaner is driven.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A position sensing device for mobile robots, comprising:
a light-receiving element configured such that light is focused on different positions of the light-receiving element according to the distance from an obstruction, from which the light is reflected;
a light-emitting element configured to emit the light, which is reflected by the obstruction and is incident on the light-receiving element, in a straight line, the light-emitting element serving to emit the light at a predetermined angle to the external jamming light such that an imaginary obstruction formed by an external jamming light incident on the light-receiving element is positioned out of an effective sensing range, within which the mobile robot is driven, among a sensible range of the distance from the obstruction; and
a signal processing unit configured to calculate the distance from the obstruction based on the position where the light incident on the light-receiving element is focused.

2. The position sensing device as set forth in claim 1, further comprising:
an incorrect signal processing unit configured to determine whether the obstruction is present within the distance considering the change of the distance sensed by the position sensing device while the mobile robot is driven.

3. The position sensing device as set forth in claim 1, wherein the light-emitting element comprises:
an infrared light-emitting diode for emitting infrared light; and
a light-transmitting lens for condensing the infrared light emitted from the infrared light-emitting diode such that the infrared light emitted from the infrared light-emitting diode is advanced in a straight line.

4. The position sensing device as set forth in claim 1, wherein the light-receiving element comprises:
a light-receiving lens for condensing the light reflected by the obstruction; and
a position-sensitive detector configured such that the light condensed by the light-receiving lens is focused on the position-sensitive detector.

5. The position sensing device as set forth in claim 1, wherein the light-emitting element is configured to emit the light at a predetermined angle, at which the degree of deviation in position of the imaginary obstruction sensed by the light-receiving element out of the effective sensing range is greater than the minimum unit distance distinguishable according to the accuracy of the signal processing unit.

6. The position sensing device as set forth in claim 1, wherein the light-emitting element is configured to emit the light at a predetermined angle, at which the light emitted from the light-emitting element is directed to a floor of a moving space, which is the maximum distance of the effective sensing range.

7. A robot cleaner comprising:
at least one position sensing device for emitting light to a floor of a cleaning space at a predetermined angle to the floor of the cleaning space such that the light emitted from the at least one position sensing device is distinguished from an external jamming light to sense the distance from an obstruction, from which the light is reflected; and
an information processing unit for transmitting a signal to the at least one position sensing device and receiving a signal from the at least one position sensing device to control a drive unit such that the robot cleaner cleans the cleaning space while the robot is driven in the cleaning space.

8. The robot cleaner as set forth in claim 7, further comprising:
a case forming the contour of a main body;
a cleaning unit mounted at the main body for cleaning the cleaning space; and
a drive unit for driving the main body such that the main body is moved on the floor of the cleaning space while supporting the main body.

9. The robot cleaner as set forth in claim 7, wherein the at least one position sensing device comprises:
a light-emitting element configured to emit light in a straight line;
a light-receiving element configured such that the light is focused on different positions of the light-receiving element according to the distance from the obstruction, from which the light is reflected; and
a signal processing unit configured to calculate the distance from the obstruction based on the position where the light incident on the light-receiving element is focused.

10. The robot cleaner as set forth in claim 9, wherein the light-emitting element comprises:
an infrared light-emitting diode for emitting infrared light; and
a light-transmitting lens for condensing the infrared light emitted from the infrared light-emitting diode such that the infrared light emitted from the infrared light-emitting diode is advanced in a straight line.

11. The robot cleaner as set forth in claim 9, wherein the light-receiving element comprises:
a light-receiving lens for condensing the light reflected by the obstruction; and
a position-sensitive detector configured such that the light condensed by the light-receiving lens is focused on the position-sensitive detector.

12. The robot cleaner as set forth in claim 9, wherein the light-emitting element is configured to emit the light at a predetermined angle, at which the degree of deviation in position of an imaginary obstruction sensed by the light-receiving element out of an effective sensing range is greater than the minimum unit distance distinguishable according to the accuracy of the signal processing unit.

13. The robot cleaner as set forth in claim 9, wherein the light-emitting element is configured to emit the light at an angle of between 10 and 15 degrees to the floor of the cleaning space.

14. The robot cleaner as set forth in claim 8, further comprising:
an incorrect signal processing unit incorporated in the information processing unit or configured to transmit a signal to the information processing unit and receive a signal from the information processing unit for determining whether the obstruction is present within the distance considering the change of the distance sensed by the at least one position sensing device while the robot cleaner is driven.

15. The robot cleaner as set forth in claim 14, wherein the incorrect signal processing unit performs an algorithm comprising:
a first step of driving the robot cleaner;
a second step of sensing an obstruction within the effective sensing range using the at least one position sensing device;
a third step of driving the robot cleaner in correspondence to the obstruction;
a fourth step of determining whether the distance from the obstruction is increased;
a fifth step of determining whether the robot cleaner approaches the obstruction; and
a sixth step of detouring the obstruction or stopping the movement of the robot cleaner when the robot cleaner approaches the obstruction.

16. The robot cleaner as set forth in claim 15, wherein, at the first step,
the second step is frequently called while the mobile robot is driven.

17. The robot cleaner as set forth in claim 15, wherein, at the fourth step,
when the distance from the obstruction is increased, the process returns to the second step, and
when the distance from the obstruction is not increased, the process moves to the fifth step.

18. The robot cleaner as set forth in claim 7, wherein the at least one position sensing device comprises a plurality of position sensing devices, some of which are configured such that the angles between lights emitted from the respective position sensing devices and the floor of the cleaning space are different.

19. The robot cleaner as set forth in claim 7, wherein the at least one position sensing device comprises a plurality of position sensing devices, some of which are configured such that the heights of the respective position sensing devices from the floor of the cleaning space are different.

20. The robot cleaner as set forth in claim 7, wherein the at least one position sensing device comprises a plurality of position sensing devices, some of which are configured such that the heights of the respective position sensing devices from the floor of the cleaning space are the same, and the angles between lights emitted from the respective position sensing devices disposed at the same height and the floor of the cleaning space are the same.

21. The robot cleaner as set forth in claim 7, wherein the at least one position sensing device comprises a plurality of position sensing devices, some of which are configured to emit light in the same direction although the heights and the light-emitting angles of the respective position sensing devices are different.
